(19) United States
(12) Patent Application Publication
(10) Pub. No.: US 2009/0323540 A1
(43) Pub. Date: Dec. 31, 2009

(54) ELECTRONIC DEVICE, SYSTEM ON CHIP AND METHOD FOR MONITORING DATA TRAFFIC

(75) Inventors: Kees G. W. Goossens, Eindhoven (NL); Calin Ciordas, Eindhoven (NL); Andrei Radulescu, Eindhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/307,404

(22) PCT Filed: Jul. 3, 2007
(86) PCT No.: PCT/IB07/52590

§ 371 Date: Aug. 18, 2009

(30) Foreign Application Priority Data
Jul. 5, 2006 (EP) 06116609.6

(51) Int. Cl. H04L 12/26

(52) U.S. Cl. 370/252

(57) ABSTRACT

An electronic device is provided which comprises a plurality of processing units (IP1-IP6; M1-M4), a network-based interconnect (N) with a plurality of network links (L1-L6) and a network interface (NI; MNI; DNI) which is associated to at least one of the processing units (IP1-IP6; M1-M4) and which serves to couple the processing units (IP1-IP6; M1-M4) to the network-based interconnect (N). The plurality of processing units (IP1-IP6; M1-M4) communicate among each other via a plurality of communication paths (C1-C4). At least two communication paths (C1-C4) are merged along the at least one shared network link (L1-L6) if a combined bandwidth of the at least two communication paths does not exceed an available bandwidth of the at least one shared network link (L1-L6).

### FIELD OF INVENTION

The invention relates to an electronic device, system on chip and method for monitoring data traffic.

### BACKGROUND OF THE INVENTION

Networks on chips NOC proved to be scalable interconnect structures in particular for systems on chip which could become possible solutions for future on chip interconnections between so-called IP blocks, i.e. intellectual property blocks. IP blocks are usually modules on chip with a specific function like CPUs, memories, digital signal processors or the like. The IP blocks communicate with each other via the network on chip. The network on chip is typically composed of network interfaces and routers. The network interfaces serve to provide an interface between the IP block and the network on chip, i.e. they translate the information from the IP block to information which the network on chip can understand and vice versa. The routers serve to transport data from one network interface to another. For best effort communication, there is no guarantee regarding the latency of the throughput of the communication. For guaranteed throughput services, an exact value for the latency and throughput is required.

The communication within a network on chip NOC is typically packet-based, i.e. the packets are forwarded between the routers or between routers and network interfaces. A packet typically consists of a header and payload.

To monitor the data traffic via the network on chip, probes can be attached to components of the network on chip, i.e. routers and network interfaces, and may allow a debugging of data to be generated on-chip. The probes can be organized in a monitoring system as described in “An event-based network-on-chip monitoring service” by Ciordas et al., in Proc. Int'l High-Level Design Validation and Test Workshop (HLDVT), November 2004.

A sniffer probe allows (non-intrusive) an access to functional data from a network link and/or a NoC component. Sniffer probes can be arranged such that they are able to sniff from a connection passing that link. Sniffing is at least part of the data traffic required for debugging and constitutes a requirement for other debug-related components like analyzers or event-generators and data/event-filters. Data generated by sniffers is sent towards the monitoring service access point (MSA) via a debug connection. The monitoring service access point constitutes a centralized access point for the monitoring data. In order to sniff the whole traffic from a connection, the bandwidth required for the debug connection will correspond to more or less to the bandwidth of the sniffed connection.

### SUMMARY OF THE INVENTION

It is an object of the invention to provide an electronic device which enables a more efficient bandwidth utilization.

This object is solved by an electronic device according to claim 1, by a system on chip according to claim 7 and by a method for monitoring data traffic according to claim 8.

Therefore, an electronic device is provided which comprises a plurality of processing units, a network-based interconnect with a plurality of network links and a network interface which is associated to at least one of the processing units and which serves to couple the processing units to the network-based interconnect. The plurality of processing units communicate among each other via a plurality of communication paths. At least two communication paths are merged along the at least one shared network link if a combined bandwidth of the at least two communication paths does not exceed an available bandwidth of the at least one shared network link.

Accordingly, two communications can be merged if their bandwidths or the combination of their bandwidths does not exceed the available bandwidth of a network link. In other words, if the two communications share at least one network link and if their respective bandwidths are less than the basic bandwidth of the link, these two communications can be merged in at least one shared network link.

In an aspect of the present invention, the network-based interconnect comprises a plurality of routers coupled by the network links. The at least two communications are then merged in a router which is coupled to the network link shared by the two communications (claim 2). Therefore, the merging of the two communications is performed in the router immediately adjacent to the shared link.

In a further aspect of the present invention, the communications are merged in one of the network interfaces (claim 3).

In still a further aspect of the present invention, the network interface comprises a de-multiplexer for receiving data from a first communication and at least two first buffers coupled to the output of the de-multiplexer. The electronic device furthermore comprises a first multiplexer coupled to the at least two second buffers and a second multiplexer at its input. The second multiplexer is coupled to a buffer at the output of the de-multiplexer and a buffer is coupled to an input port of the network interface. The data from one buffer or the data from another buffer is forwarded by the second multiplexer to the first multiplexer based on an arbitration of an arbiter coupled to the second multiplexer (claim 4). Hence, the merging of two communications can be performed in a network interface by providing an additional multiplexer which is controlled by an arbiter such that the two communications can be merged if required.

In a further aspect of the present invention, the network interface comprises a first de-multiplexer, at least two buffers coupled to the output of the de-multiplexer, a second de-multiplexer for receiving data from a first communication and for forwarding data to the first de-multiplexer or to a buffer. The network interface furthermore comprises a first multiplexer coupled to the at least two buffers at its input and a second multiplexer coupled to the output of the first multiplexer. The second multiplexer is coupled to the buffer and to the output of the first multiplexer. The data from the buffer or the data from the first multiplexer are output to the second multiplexer according to an arbitration of an arbiter coupled to the second multiplexer (claim 5).

In a further aspect of the present invention, the network interface comprises an input and an output buffer. One of the plurality of processing units is embodied as a monitoring unit and comprises a multiplexer, an input buffer, an event generator and an arbiter. The multiplexer outputs data from the input buffer or data from the event generator according to an arbitration of the arbiter coupled to the second multiplexer (claim 6). Accordingly, the merging of the two communications is performed within the monitor unit.

The invention also relates to a system on chip which comprises a plurality of processing units, a network-based interconnect with a plurality of network links and a network interface which is associated to at least one of the processing units and which serves to couple the processing units to the network-based interconnect. The plurality of processing units communicate among each other via a plurality of communication paths. At least two communication paths are merged along the at least one shared network link if a combined bandwidth of the at least two communications does not exceed an available bandwidth of the at least one shared network link.

The invention also relates to a method for monitoring data traffic within an electronic device having a plurality of processing units, a network-based interconnect with a plurality of network links and a network interface associated to at least one of the processing units. The network interface couples the processing units to the network-based interconnect. The plurality of processing units communicate among each other via a plurality of communication paths. At least two communication paths are merged along at least one shared network link if a combined bandwidth of the at least two communications does not exceed an available bandwidth of the at least one shared network link.

The invention also relates to the idea to totally or partially merging several low-bandwidth debug or monitoring connections or communication paths into one connection or one communication to more efficiently use the available bandwidth even to transfer data which is smaller than a time slot within a TDMA transfer of data.

### BRIEF DESCRIPTION OF THE INVENTION

These and other aspects of the invention will be apparent from and elucidated with reference to the embodiment(s) described hereinafter.

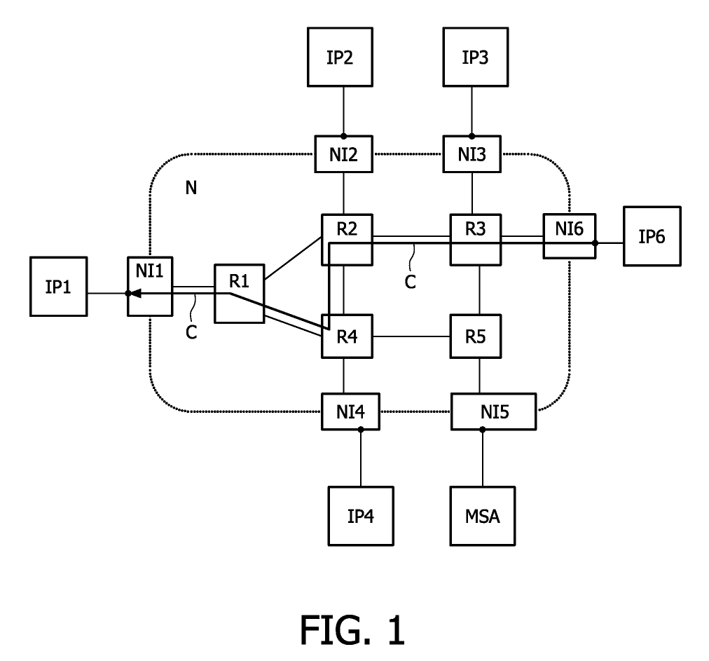

FIG. 1 a block diagram of a basic structure of a system on chip with a network on chip interconnect according to the invention;

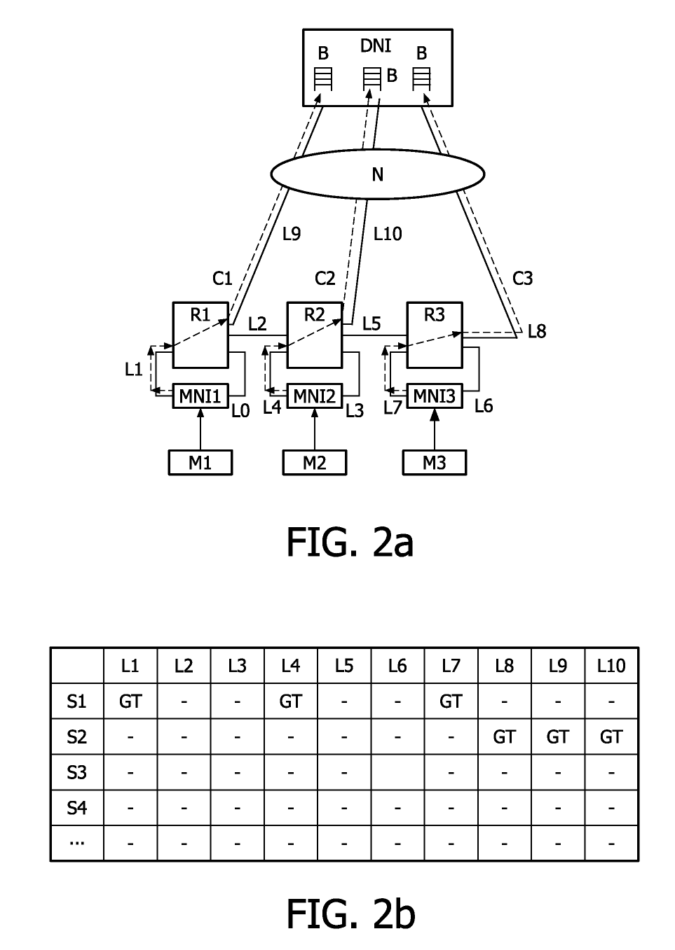

FIG. 2a shows a block diagram of a system on chip according to a first embodiment;

FIG. 2b shows a representation of a slot table for the slot reservation of connections in the system on chip according to FIG. 2a;

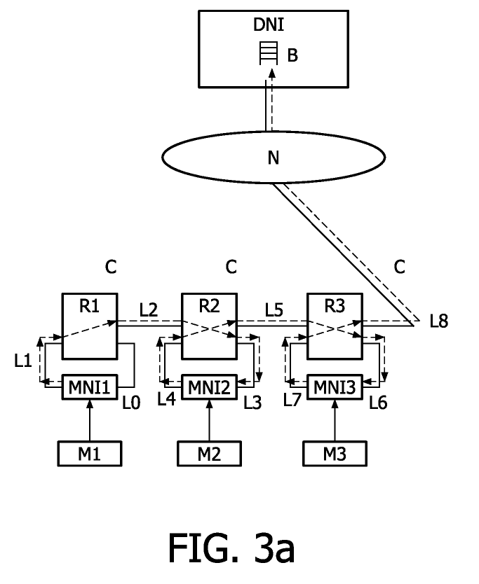

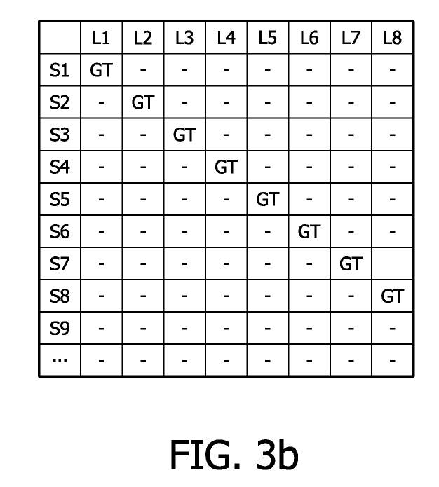

FIG. 3a shows a block diagram of part of the system on chip according to FIG. 1 according to a second embodiment;

FIG. 3b shows a representation of a slot table reservation according to the second embodiment;

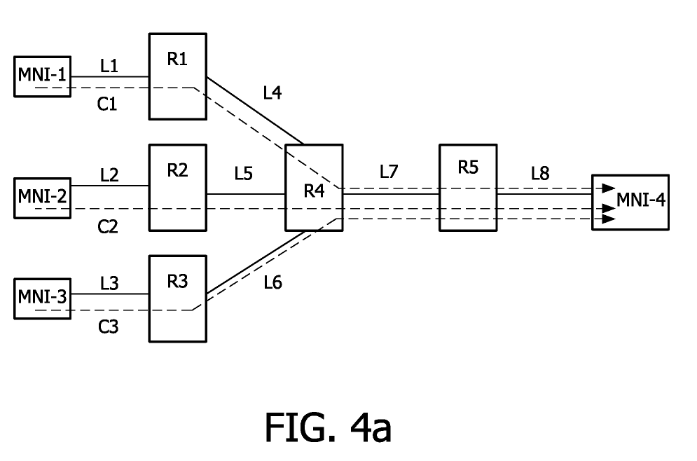

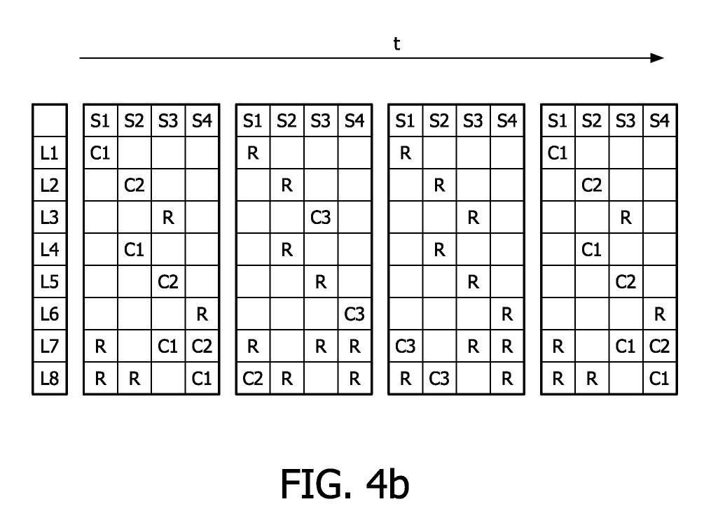

FIG. 4a shows a block diagram of part of a system on chip according to FIG. 1 according to a third embodiment;

FIG. 4b shows a representation of a slot table reservation according to the third embodiment;

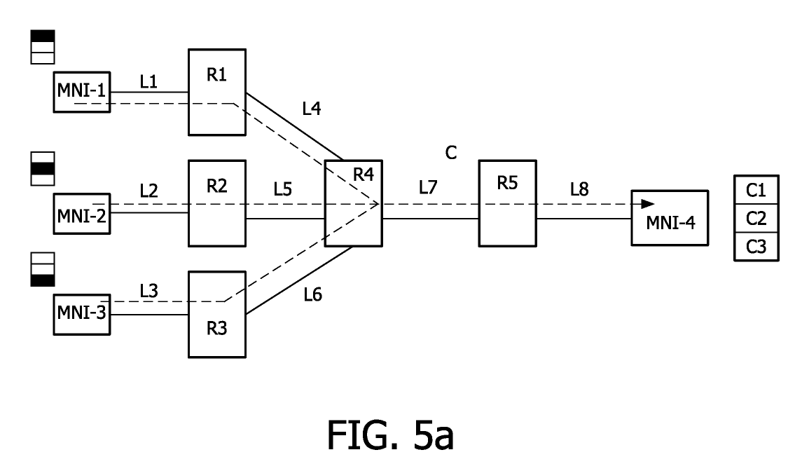

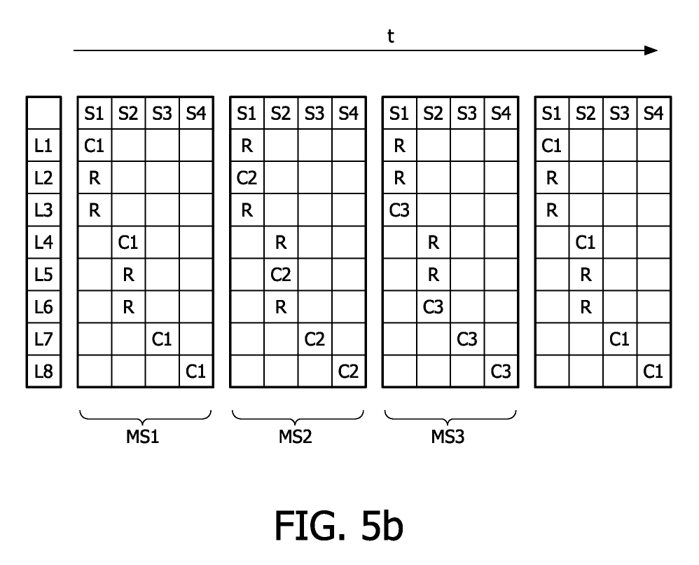

FIG. 5a shows a block diagram of part of the system on chip according to FIG. 1 according to a fourth embodiment;

FIG. 5b shows a representation of a slot table reservation according to the fourth embodiment;

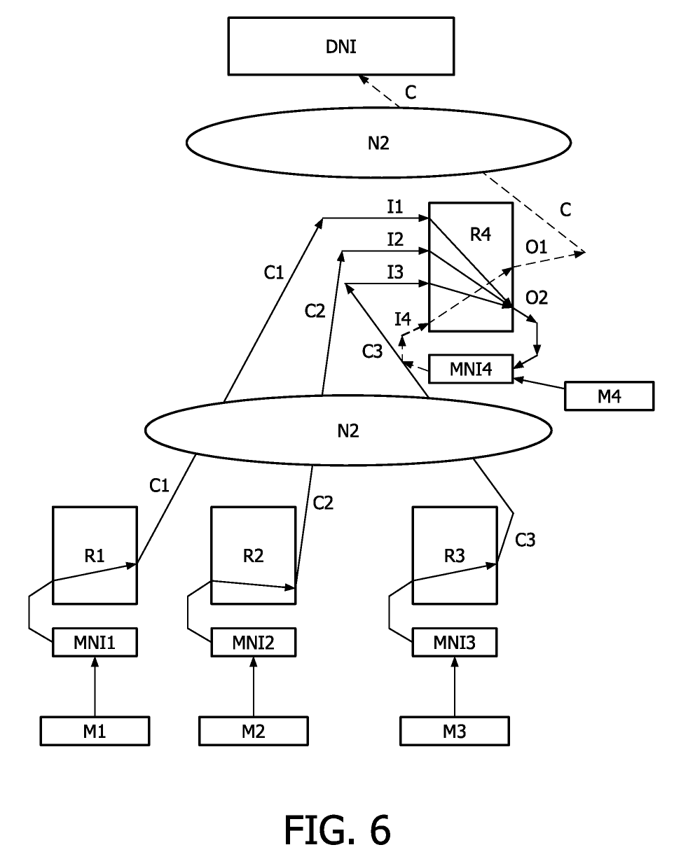

FIG. 6 shows a block diagram of a part of a system on chip according to a fifth embodiment;

FIG. 7 shows a block diagram of a network interface according to the invention;

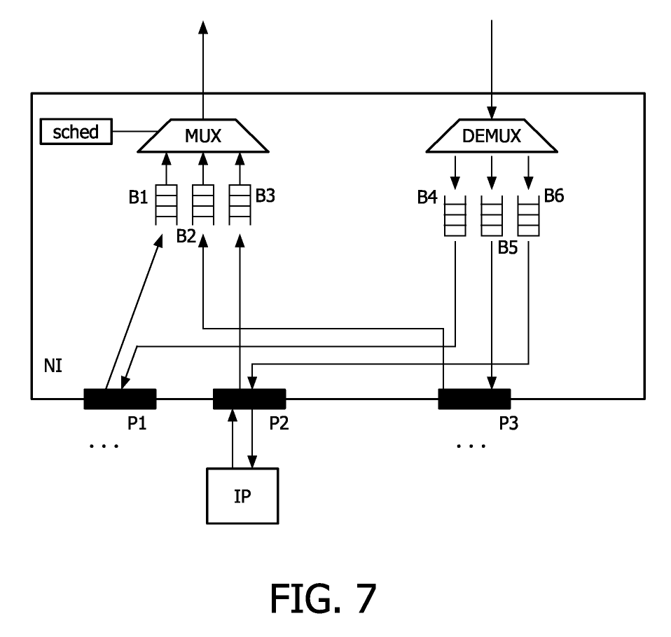

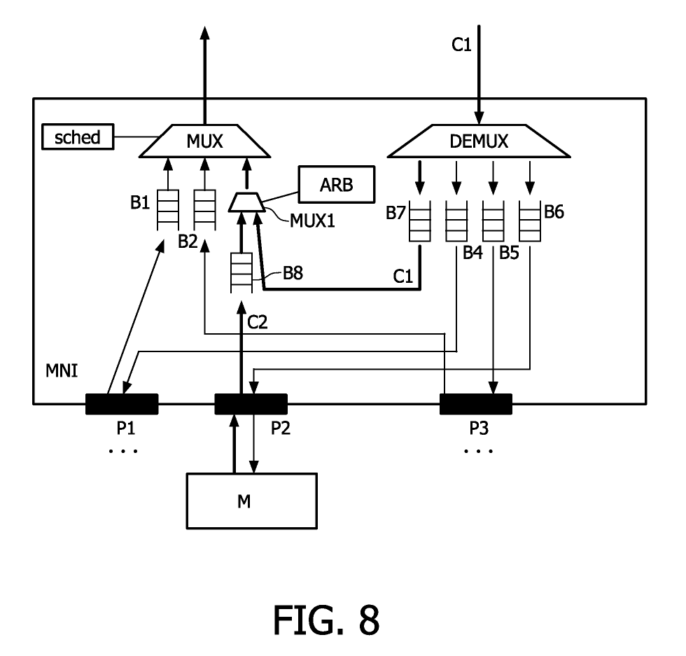

FIG. 8 shows a schematic representation of a monitoring network interface according to a sixth embodiment;

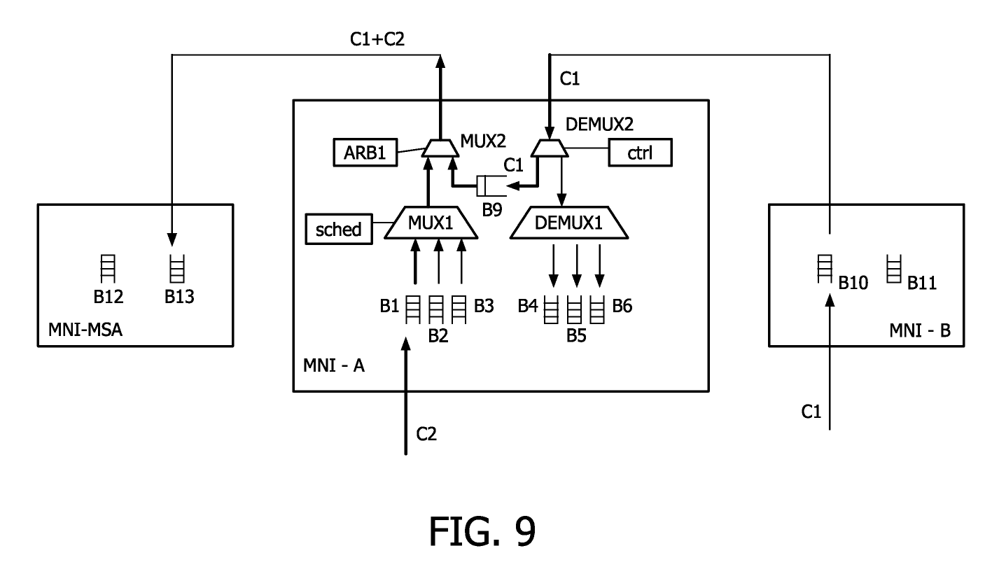

FIG. 9 shows a schematic representation of a monitoring network interface according to a seventh embodiment;

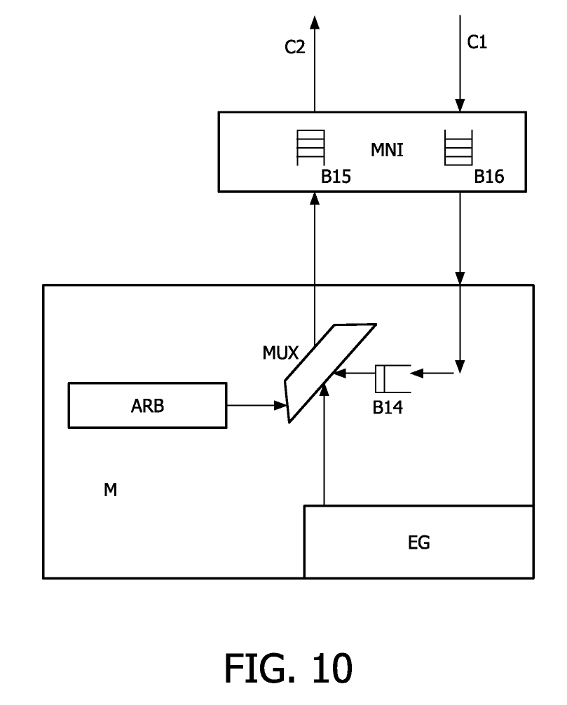

FIG. 10 shows a schematic representation of a monitor according to an eight embodiment;

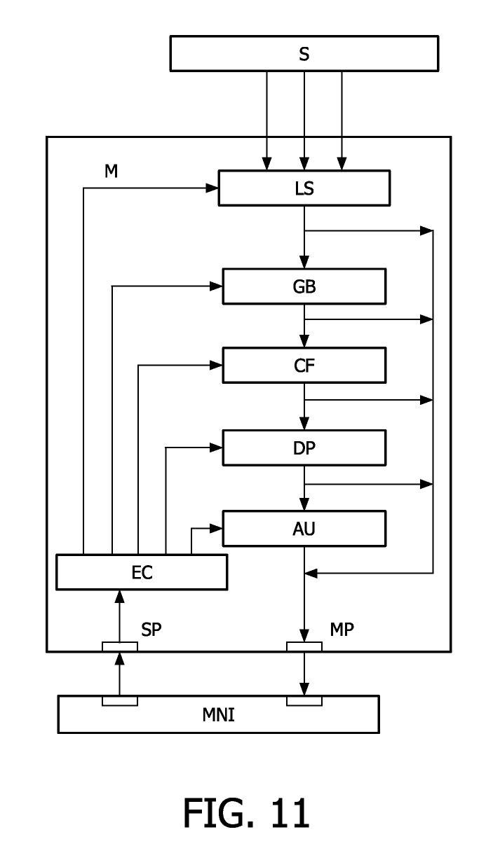

FIG. 11 shows a block diagram of a detailed monitoring unit according to a ninth embodiment; and

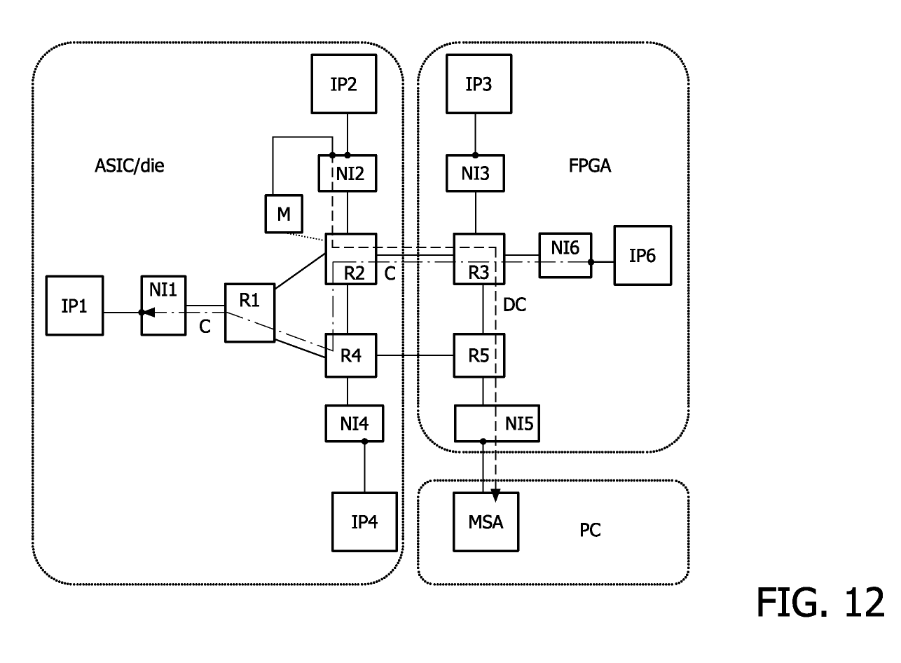

FIG. 12 shows a block diagram of a system according to a tenth embodiment.

### DETAILED DESCRIPTION OF EMBODIMENTS

FIG. 1 shows a block diagram of a basic structure of a system on chip (or an electronic device) with a network on chip interconnect according to the invention. A plurality of IP blocks IP1-IP6 are coupled to each other via a network on chip N. The network NOC comprises network interfaces NI for providing an interface between the IP block IP and the network on chip N. The network on chip N furthermore comprises a plurality of routers R1-R5. The network interface NI1-NI6 serves to translate the information from the IP block to a protocol, which can be handled by the network on chip N and vice versa. The routers R serve to transport the data from one network interface NI to another. The communication between the network interfaces NI will not only depend on the number of routers R in between them, but also on the topology of the routers R. The routers R may be fully connected, connected in a 2D mesh, connected in a linear array, connected in a torus, connected in a folded torus, connected in a binary tree or in a fat-tree fashion in a custom or irregular topology. The IP block IP can be implemented as modules on chip with a specific or dedicated function such as CPU, memory, digital signal processors or the like. Furthermore, a user connection or a user communication path C with a bandwidth of e.g. 100 MB/s between NI6 and NI1 serving for the communication of IP6 with IP1 is shown. A monitoring service access unit is provided as a central access point for monitoring the data.

The information from the IP block IP that is transferred via the network on chip NOC will be translated at the network interface NI into packets with variable length. The information from the IP block IP will typically comprise a command followed by an address and an actual data to be transported over the network. The network interface NI will divide the information from the IP block IP into pieces called packets and will add a packet header to each of the packets. Such a packet header comprises extra information that allows the transmission of the data over the network (e.g. destination address or routing path, and flow control information). Accordingly, each packet is divided into flits (flow control digit), which can travel through the network on chip. The flit can be seen as the smallest granularity at which control is taken place. An end-to-end flow control is necessary to ensure that data is not send unless there is sufficient space available in the destination buffer.

The communication between the IP blocks can be based on a connection or it can be based on a connection-less communication (i.e. a non-broadcast communication, e.g. a multi-layer bus, an AXI bus, an AHB bus, a switch-based bus, a multi-chip interconnect, or multi-chip hop interconnects). The network may in fact be a collection (hierarchically arranged or otherwise) of sub-networks or sub-interconnect structures, may span over multiple dies (e.g. in a system in package) or over multiple chips (including multiple ASICs, ASSPs, and FPGAs). Moreover, if the system is being prototyped, the network may connect dies, chips (including especially FPGAs), and computers (PCs) that run prototyping & debugging software, the monitoring service access point MSA, or functional parts of the system. The interconnect for debugging data is preferably the same as the interconnect for functional, as shown in the embodiments. It may, however, also be a (partially) different interconnect (e.g. a lower speed token, ring, bus or network).

FIG. 2a shows a block diagram of a system on chip according to a first embodiment. Here, three monitors M1, M2, M3 are shown which are coupled to respective routers R1-R3 by means of monitoring network interfaces MNI1-MNI3. The routers R1-R3 are coupled to a destination network interface DNI via the network on chip N such that the data from the monitors M1-M3 can be forwarded to the destination network interface DNI via three connections C1, C2, C3, respectively. The destination network interface DNI comprises three buffers B (i.e. a buffer per connection). In particular, the first router R1 is coupled via a link L9 to the network N. The router R2 is coupled via a link L10 to the network N and the router R3 is coupled via a link L8 to the network N. Preferably, the monitoring network interfaces MNI are implemented as standard network interfaces which are connected to the monitors M1-M3 to couple the monitors M to the network N. The destination network interface DNI can also be implemented as a standard network interface which is used to connect a master IP block IP to the network NOC if this IP block requires a monitoring service. The links L0, L1, L3, L4, L6, L7 can be unidirectional links, while the links L2, L5, L8, L9, L10 can be bidirectional. The links L0 and L1 (and links L3+L4 and links L6+L7) form one bidirectional link connecting the monitoring network interface MNI to router R1, R2 and R3, respectively. The connections C1, C2 and C3 are preferably low-bandwidth connections which may only require less than the basic time slot of the system, e.g. like 1/10 of the atomic unit of reservation ( 1/10 of U) like a timeslot. However, as the minimum reservation unit corresponds to U, a slot or a timeslot has to be reserved in the routers R1, R2 and R3 even if this timeslot is not fully used. Accordingly, a slot is required for each of the connections in the routers and in particular along the connection path to the destination network interface DNI.

FIG. 2b shows a representation of a slot table for the slot reservation of connections in the system on chip according to FIG. 2a. The first connection C1 extends from the monitoring network interface MNI1 associated to the first monitor M1 to the router R1, along the link L9 to the network N and then to the destination network interface DNI. The second connection C2 extends from the monitoring network interface MNI2 associated to the second monitor M2 via the link L4 to the second router R2 and from the second router R2 via link L10 to the destination network interface DNI. The third connection C3 extends from the monitoring network interface MNI3 associated to the third monitor M3 via the link L7 to the third router R3 and from the router R3 via link L8 to the destination network interface DNI. Hence, for the first slot S1, the link L1, the link L4 and the link L7 are reserved for the first, second and third connection C1-C3, respectively. The second slot S2 reserves the link L8, the link L9 and the link L10 for the third, first and second connection, respectively.

FIG. 3a shows a block diagram of part of the system on chip according to FIG. 1 according to a second embodiment. The arrangements of the monitors, routers and monitoring network interfaces according to FIG. 3a corresponds to the arrangement according to FIG. 2a. The only difference between these two arrangements is that only the link L8 is used between the routers R1-R3 and the network on chip N as well as the destination network interface DNI. Instead of providing a link between each of the routers and the network N, only a single link L8 is provided from the router R3 to the network NOC. The data from the monitor M1 is routed from the monitoring network interface MNI1 via links L1 and L2 to the router R2 and then looped via link L3 to monitoring network interface MNI2. The data from the second monitor M2 is combined with the data form monitor M1 either in network interface MNI2 or in monitor M2.

Then the resulting data is sent via links L4 and L5 to the router R3 and then via link L6 to MNI3. The data from the monitor M3 is accordingly combined with the already combined data from the monitors M1 and M2 in MNI3 or M3. The resulting data from the first, second and third monitor M1-M3 are transmitted via the links L7 and L8.

The three connections C1-C3 are merged into a single connection such that merely a single connection is required from the network interface MNI3 to the network. Furthermore, the destination network interface DNI only requires one buffer B for the connection.

The aggregate bandwidth of the connection C is, for our example, 3/10 ( 1/10 for C1+ 1/10 for C2+ 1/10 for C3) of 1 U. On the path from router R3 to destination network interface NI merely 1 slot must be reserved in each router. The combination of data in the monitoring network interface MNI will be described below in more detail with respect to FIG. 8 and FIG. 9. The combination of data in monitor M will be described below in more detail with respect to FIG. 10.

FIG. 3b shows a representation of a slot table reservation according to the second embodiment. Here, it can be seen that for any given slot S1-S8 only a single slot is reserved for each of the links L1-L8. If the table according to the second embodiment is compared to the table according to the first embodiment, it can be seen that for the slot S1, merely a single link is reserved as compared to three links according to FIG. 2b.

According to the second embodiment, only one connection (with 1 slot/router reserved) on the path from router R3 to destination network interface NI is required instead of having 3 connections (with 1 slot/router reserved), with at least partly the same path.

Therefore, only ⅓ of the bandwidth initially reserved is required after the merging, fewer slots are used in the routers on the path of the merged connection, and fewer buffers are required at the destination network interface NI (i.e. one buffer B instead of three buffers according to FIG. 2a).

FIG. 4a shows a block diagram of part of a system on chip according to FIG. 1 according to a third embodiment. Here, merely the monitoring network interfaces MNI1-MNI4 and the routers R1-R5 are shown. A first connection C1 extends from the monitoring network interface MNI1 via the router R1, R4 and R5 to the monitoring network interface MNI4. The second connection C2 extends from the monitoring network interface MNI2 to the monitoring network interface MNI4 via the router R2, R4 and R5. The third connection C3 extends from the monitoring network interface MNI3 to the monitoring network interface MNI4 via the router R3, R4 and R5. Accordingly, the link L7 and L8 between the router R4 and R5 and between the router R5 and the monitoring network interface MNI4 is used by the three connections. As an illustrative example, each of the connections C1-C3 occupies ⅓ of the available bandwidth.

If a monitoring network interface MNI with a monitor is not available in the system, a partial merging can still be performed but without looping through the monitoring network interface MNI as discussed below.

FIG. 4b shows a representation of the slot table reservation according to the third embodiment. In particular, the slot table reservation is shown for different points of time t. The usage or the reservation of each link is shown for the time slots S1-S4. Those slots reserved for the first connection are indicated by C1. Those slots required by the second connection are indicated by C2 and those slots required for the third connection are indicated by C3. Those slots which are reserved but not actually induced are indicated by R.

FIG. 5a shows a block diagram of part of the system on chip according to FIG. 1 according to a fourth embodiment. The monitoring network interfaces MNI and the routers R according to FIG. 5a correspond to the monitoring network interfaces MNI and the routers R according to FIG. 4a. The path of the first, second and third connection C1-C3 correspond to the path of the first, second and third connection C1-C3 according to FIG. 4a. However, the connections C1-C3 are merged into a single connection C in the router R4.

FIG. 5b shows a representation of the slot table reservation according to the fourth embodiment. According to the fourth embodiment, the three connections C1-C3 are merged into a single connection C. This can be achieved by sharing the links L7 and L8 among these connections.

Besides the slot table, each of the monitoring network interfaces MNIs may maintain a minislot MS1-MS3 of size 3. As the original connections only require ⅓ of the bandwidth available, only one packet is generated at 3 revolutions of the slot table. The minislot MS1-MS3 contain the information for the monitoring network interface MNI in which slot table revolution it can place the data on the network N. If the above-mentioned minislots MS1-MS3 are to be used effectively, the scheduling of the data transfer needs to be adapted. Guaranteed throughput flits may only stay for one flit clock in a router. Accordingly, as the links L7 and L8 are shared among the connections, i.e. the links are shared within the same slot, the time slot reservation in any previous links must be rearranged. This can clearly be seen if the slot time reservation table according to FIG. 5b is compared to the table according to FIG. 4b.

In the same way the destination MNI keeps a minislot in which it knows from which connection it receives data at each slot table revolution.

FIG. 6 shows a block diagram of a part of a system on chip according to a fifth embodiment. The architecture of the system on chip according to FIG. 6 substantially corresponds to the architecture of the system on chip according to FIG. 3a. The only difference is that apart from the three monitors M1-M3 with their associated monitoring network interfaces MNI1-MNI3 and the corresponding routers R1-R3 which are coupled to part of the network N1, a fourth monitoring unit M4 is coupled to a router R4 via a fourth monitoring network interface MNI4. The router R4 is coupled to the destination network interface DNI via a part of the network N2. The fifth embodiment constitutes a combination of the second and fourth embodiment. Data from the monitors M1, M2 and M3 is first merged on the link and then looped and combined with local data from monitor M4 either in MNI4 or in the M4 according to the second embodiment.

It should be noted it may not always be possible to loop data through several routers e.g. due to the fact that one path through all the probed or monitored routers is not possible, or because of the spatial distribution of event generators.

According to the fifth embodiment, even if it is not possible to loop data through several routers, part of the reserved bandwidth may be saved by partially merging the three connections C1, C2 and C3 into one connection C at a certain point in the network N, e.g. the router R4 to loop through its corresponding monitoring network interface MNI and aggregating in the connection C also the local data of monitor M4. Accordingly, only one slot has to be reserved for connection C on the path from the router R4 to the destination network interface DNI. Accordingly, the saving of the bandwidth only applies for the path between the router R4 and the destination network interface NI.

As a non-limiting example, slot table size can be 256, and the connection C1, C2, and C3 may each require 1/10 of the minimum reservation unit. Accordingly, one packet may be required for each 10 revolutions of the slot table of 256 slots. If the packets from different connections arrive in different slot table revolutions no buffering is required in the monitoring network interface MNI associated to the router R4. This can be ensured by a) using buffering and counters to prevent monitoring network interface MNIs to send more than they reserved (e.g. rate-based) or by b) using minislot tables to select the subslot in which monitoring network interface MNIs can send data, which should be performed on a contention free.

It should be noted that the second, third, fourth and fifth embodiments can be combined such that existing connections can be partially or totally merged.

FIG. 7 shows a block diagram of a network interface according to the invention. The network interface NI comprises a multiplexer MUX, a de-multiplexer DEMUX, a scheduler SCHED and several buffers B. Three buffers B1-B3 are coupled to the multiplexer MUX and the data of these three buffers B1-B3 (which are received from the three ports) are output by the multiplexer MUX according to the scheduler SCHED. The de-multiplexer DEMUX receives data and demultiplexes the data such that the data is stored in three buffers B4-B6 and may be outputted to the three ports P1-P3.

FIG. 8 shows a schematic representation of a monitoring network interface according to a sixth embodiment. The structure of the monitoring network interface according to FIG. 8 substantially corresponds to the structure of the network interface according to FIG. 7. In addition, a buffer B7 is provided which is coupled to the de-multiplexer DEMUX and a further multiplexer MUX1 is coupled at the output of the buffer B7 and the input of the multiplexer MUX. The multiplexer MUX1 receives the output from the buffer B8 and the output from the buffer B7 coupled to the de-multiplexer DEMUX. The buffer B8 receives data of the second connection C2 from the second port P2, i.e. from the monitor M. The network interface MNI is preferably coupled to a monitor M via the second port P2 which generates a data traffic which is handled as a second connection C2. The data from the monitor M is buffered in the buffer B8. The output of the buffer B7 is coupled to the de-multiplexer, i.e. the data traffic from the connection C1, and the output of the buffer B8 are input to the multiplexer MUX1, wherein the multiplexer MUX1 is controlled by an arbiter ARB. The arbiter ARB serves to select the data from connection C1 or the data from connection C2. The arbiter ARB may perform any arbitration policy like round-robin or the like. Accordingly, by the network interface according to FIG. 8 a looping or forwarding of data can be achieved. According to the network interface of FIG. 8, the arbiter ARB decides from which connection (C1 or C2) the data is forwarded to the monitoring service access unit MSA based on the current slot and minislot. Therefore, no further modifications are required to cope with the flow control.

FIG. 9 shows a schematic representation of a monitoring network interface according to a seventh embodiment. The structure of the monitoring network interface according to FIG. 9 is based on the structure of the network interface according to FIG. 7. However, according to the seventh embodiment a second multiplexer MUX2 controlled by an arbiter ARB1 is arranged at the output of the first multiplexer MUX and a second de-multiplexer DEMUX2 is arranged at the input of the de-multiplexer DEMUX and is controlled by a control unit ctrl. The second de-multiplexer DEMUX receives data from the first connection C1 and forwards this data to the first de-multiplexer DEMUX or to the second multiplexer MUX2 via an additional buffer B9. Therefore, the second multiplexer MUX2 receives data either from the first multiplexer (the second connection C2) or from the buffer B9 buffering data from the first connection C1.

A level of indirection can be added in the monitoring network interface MNI-A. The control unit ctrl controls whether the data at the input of the network interface NI is for the standard connections or if for the merged connection. If data is for the merged connection it is placed in the C1 queue buffer B9. If is not for the merged connection it is placed in the regular queue. The arbiter ARB1 decides based on the current slot and minislot from which connection (C1 or C2) the data will be sent towards the monitoring service access unit MSA.

However, the flow control (in particular the end-to-end flow control) according to FIG. 9 needs to be amended. Flow control data (end-to-end flow control) is added in the packet header at the packetization in the source network interface NI, and it is addressed to a single destination network interface DNI. For the packetization a path from the source network interface NI to the destination network interface NI, and a the ID of the queue queueID of the destination network interface NI is required. As the flow control (end-to-end flow control) sent from monitoring network interface MNI-MSA has to reach both monitoring network interface MNI-A and monitoring network interface MNI-B the flow control may become a problem.

This can be solved if the monitoring network interface MNI-MSA keeps or stores the path from monitoring network interface MNI-MSA to monitoring network interface MNI-B, (i.e. the path from the monitoring network interface MNI-MSA to the monitoring network interface MNI-B corresponds to the path from monitoring network interface MNI-MSA to monitoring network interface MNI-A and the path from monitoring network interface MNI-A to MNI-B) and the ID of the queue queueID in the monitoring network interface MNI-B. Moreover, the monitoring network interface MSA-A can keep the queueID of its own queue. At packetization in the monitoring network interface MNI-MSA, the path provided is the path from monitoring network interface MNI-MSA to monitoring network interface MNI-B, and the queueID provided is the queueID of the queue in monitoring network interface MNI-B. Flow control is sent alternatively to monitoring network interface MNI-A and monitoring network interface MNI-B.

The end-to-end flow control for the monitoring network interface MNI-B will not cause problems. However, the end-to-end flow control for the monitoring network interface MNI-A may cause problems as the path and ID of the queue queueID used at the packetization in the monitoring network interface MNI-MSA does not match the monitoring network interface MNI-A. The path to monitoring network interface MNI-A is already contained in the path to the monitoring network interface MNI-B, i.e. the packet will go through monitoring network interface MNI-A. If the monitoring network interface MNI-A receives this packet, and if it is destined for itself, it will relate the packet to the queueID of its own queue of which it has knowledge.

Alternatively, the monitoring network interface MNI-MSA may keep or store the path form the monitoring network interface MNI-MSA to the monitoring network interface MNI-A and the queueID of the queue in MNI-A. The monitoring network interface MSA-A keeps or stores the queueID of the queue in the monitoring network interface MNI-B and the path to the monitoring network interface MNI-B. Accordingly, if an end-to-end flow control packet arrives at monitoring network interface MNI-A it can be also sent to the monitoring network interface MNI-B using the information kept in monitoring network interface MSA-A. At packetization in monitoring network interface MNI-MSA, the path provided is the path from monitoring network interface MNI-MSA to monitoring network interface MNI-A, and the queueID provided is the queueID of the queue in monitoring network interface MNI-A. Here, the end-to-end flow control is sent alternatively to monitoring network interface MNI-A and monitoring network interface MNI-B. The end-to-end flow control to monitoring network interface MNI-A will not cause a problem. However, the end-to-end flow control to monitoring network interface MNI-B may cause a problem as the path and queueID used at the packetization in monitoring network interface MNI-MSA does not match the monitoring network interface MNI-B. If the monitoring network interface MNI-A receives this packet, and if the packet is not intended for itself, the path to monitoring network interface MNI-A is replaced with the path to monitoring network interface MNI-B, and the queueID of the queue in monitoring network interface MNI-A is replaced with the queueID of the queue in monitoring network interface MNI-B, i.e. the packet will go through monitoring network interface MNI-A.

FIG. 10 shows a schematic representation of a monitor according to an eight embodiment. Here, the looping or forwarding mechanism is implemented in the monitor, i.e. no modifications are required in the monitoring network interface MNI. However, this solution is more expensive with respect to buffering. Two buffers B16, B14 are required, namely one (B16) in the monitoring network interface MNI and one (B14) in the monitor while according to the sixth embodiment only one buffer is required in the monitoring network interface MNI. However, no new monitoring network interface MNI (which is a standard Network Interface) design is required.

The looping or forwarding mechanism can be either implemented in the monitoring network interface MNI according to FIG. 8 or FIG. 9 or in the monitor according to FIG. 10. The monitor is the IP from FIG. 10 connected to MNI, e.g. for debug purpose.

FIG. 11 shows a block diagram of a detailed monitoring unit according to a ninth embodiment. The monitoring unit or the transaction monitor can be coupled to a router via a sniffer S. The sniffer will forward the data traffic which passes the associated router to the monitoring unit M. The monitoring unit can be coupled to a network interface MNI via which the monitoring unit can be coupled to the network for forwarding the results of the monitoring unit. The monitoring unit may have several blocks which are used to filter the raw data from the sniffer. Preferably, these filtering blocks are coupled in series such that they filter the output of the preceding block. The network interface MNI of the monitoring unit can be implemented as a separate network interface or can be merged with existing network interfaces.

The monitoring unit can sniff all router links. The link selection unit LS will select at least one link which is to be further analyzed. An enable/configuration unit EC can be provided for enabling and configuring the monitoring unit. The monitoring unit may have two ports, namely a slave port SP through which the monitoring unit can be programmed. The second port can be implemented as a master port MP for sending the result of the monitoring to a monitoring service access point MSA via the network interface.

The link selection unit LS serves to filter the data traffic from the selected link, in particular all flits passing on the selected links are forwarded to the next filtering block. By filtering the data from the sniffer, the amount of data traffic which is to be processed by the next filtering block is reduced. In the next filtering block GB, the guaranteed throughput GT or best effort BE traffic can be filtered which will also lead to a reduction of the data traffic which still needs to be monitored and processed. The connection filtering unit CF identifies at least one selected connection for example by means of the queue identifier and the path which may uniquely identify each connection. If destination routing is used, the connection can be filtered based on the destination address (and the connection queue identifier if this is not part of the destination identifier).

Other embodiments achieving the same purpose are also possible. This can for example be programmed by the slave port SP. As the queue identifier and the path can be part of the header of the packets, this can easily be identified by the connection filtering unit CF. To identify the messages which are part of the data traffic, the packets of the selected connection need to be depacketized such that the payload thereof can be examined for any relevant messages. This is preferably performed in the depacketization unit DP. The result of this depacketization can be forwarded to an abstraction unit AU where the messages are monitored and examined to determine whether an event has taken place. The depacketization unit DP and the abstraction unit AU may be combined or separate depending on the (in)dependence of the transport and network protocols and their encoding in the packet & message headers. The respective event can be programmed by the slave port SP and the enable/configuration block.

FIG. 12 shows a block diagram of a system according to a tenth embodiment. The components of system according to the tenth embodiment substantially corresponds the components of the system on chip according to FIG. 1. However, part of the components (IP1-IP2, N11, N12, N14, R1, R2, R4) are arranged on an ASIC die, while other parts (IP3, IP6, N13, N16, N15, R3, R5) are arranged on a FPGA or a personal computer PC, i.e. the monitoring service access point MSA. Although the components of the system are distributed other several independent parts, the overall operation is not changed as compared to the first, second or third embodiment.

The principles of the invention is relevant for aggregation of any low-bandwidth GT connections (debug, functional data, performance analysis, resource management, network management) with the same destination, which do not necessitate the minimum requirements of the atomic unit of bandwidth reservation.

The principles of the invention can be used in any interconnect, e.g. networks on chip, networks spanning multiple chips, etc. where resource reservations can be made for traffic. Examples are schemes based on TDMA, rate control.

This solution significantly reduces the bandwidth usage for a set of low-bandwidth connections. It is equivalent with less over-dimensioning to support debug. It also reduces the Destination NI size because the number of connections to it is reduced. It reduces the number of resources (slots) used inside the network on chip NoC.

Furthermore, this solution is supported by the existing network on chip NoC infrastructure, and minimal extra hardware is required either in MNI or in the debug monitor to implement the looping.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be construed as limiting the scope of the claims.

1. Electronic device, comprising:
a plurality of processing units;
a network-based interconnect having a plurality of network links;
a network interface associated to at least one of the plurality of processing units for coupling the processing unit to the network-based interconnect;
wherein the plurality of processing units communicate among each other via a plurality of communication paths;
wherein at least two communication paths are merged along at least one shared network link if a combined bandwidth of the at least two communication paths does not exceed an available bandwidth of the at least one shared network link.

2. Electronic device according to claim 1, wherein
the network-based interconnect comprises a plurality of routers which are coupled by the network links,
wherein the at least two communication paths are merged in a router which is coupled to the shared network link.

3. Electronic device according to claim 1, wherein the at least two communication paths are merged in one of the network.

4. Electronic device according to claim 3, wherein
the network comprises a de-multiplexer for receiving data from a first communication and at least two first buffers coupled to the output of the de-multiplexer, and a first multiplexer coupled to at least two second buffers and a second multiplexer at its input,
wherein the second multiplexer POW His coupled to a buffer at the output of the de-multiplexer and a buffer coupled to an input port of the network interface, wherein the data from the buffer or the data from the buffer is forwarded by the second multiplexer to the first multiplexer according to an arbitration of an arbiter coupled to the second multiplexer.

5. Electronic device according to claim 3, wherein
the network interface comprises a first de-multiplexer at least two buffers coupled to the output of the de-multiplexer a second de-multiplexer for receiving data from a first communication and for forwarding data to the first de-multiplexer or to a buffer, a first multiplexer coupled to at least two buffers at its input and a second multiplexer coupled to the output of the first multiplexer,
wherein the second multiplexer is coupled to the buffer and to an output of the first multiplexer, wherein the data from the buffer or the data from the first multiplexer is outputted by the second multiplexer according to an arbitration of an arbiter coupled to the second multiplexer.

6. Electronic device according to claim 3, wherein
the network interface comprises an input and an output buffer,
one of the plurality of processing units is embodied as a monitoring unit and comprises a multiplexer, an input buffer, an event generator and an arbiter unit;
wherein the multiplexer outputs data from the input buffer or data from the event generator according to an arbitration of an arbiter coupled to the second multiplexor.

7. System on chip, comprising:
a plurality of processing units;
a network-based interconnect having a plurality of network links;
a network interface associated to at least one of the plurality of processing units for coupling the processing unit to the network-based interconnect;
wherein the plurality of processing units communicate among each other via a plurality of communication paths;
wherein at least two communication paths are merged along at least one shared network link if a combined bandwidth of the at least two communication paths does not exceed an available bandwidth of the at least one shared network link.

8. A method for monitoring data traffic within an electronic device comprising a plurality of processing units a network-based interconnect having a plurality of network links and a network interface associated to at least one of the plurality of processing units, comprising the steps of
coupling the processing units to the network-based interconnect,
wherein the plurality of processing units communicate among each other via a plurality of communication paths;
merging at least two communication paths along at least one shared network link if a combined bandwidth of the at least two communication paths does not exceed an available bandwidth of the at least one shared network link.
